(19) United States
(12) Patent Application Publication
(10) Pub. No.: US 2010/0302397 A1
(43) Pub. Date: Dec. 2, 2010

(54) Motion image data generator, system using motion image data, and methods thereof

(75) Inventors: Chien-Teng Huang, HsinChu City (TW); Chun-Huang Lin, HsinChu City (TW); Jeng-Feng Lan, HsinChu City (TW)

Correspondence Address: Tung & Associates, Suite 120, 838 W. Long Lake Road, Bloomfield Hills, MI, 48302, US

(73) Assignee: Chip Goal Electronics Corporation, R.O.C.

(21) Appl. No.: 12/660,599

(22) Filed: Mar. 2, 2010

(30) Foreign Application Priority Data
May 27, 2009 (TW) 098117849

(51) Int. Cl. H04N 5/228

(52) U.S. Cl. 348/222.1; 348/E05.031

(57) ABSTRACT

The present invention discloses a motion image data generator, a system using motion image data, and methods relating to the generator and the system. The motion image data generator comprises: a photo sensor for capturing an image and converting it to digital image data; and a motion detection and processing circuit coupled to the photo sensor for comparing two digital image data outputted from the photo sensor to determine whether there is an object moving, and generating a corresponding output. In determining whether there is a movement, an object which keeps moving by a fixed frequency is filtered out.

### BACKGROUND OF THE INVENTION

1. Field of Invention

The present invention relates to a motion image data generator, a method for generating motion image data, and a system using the motion image data, such as a monitoring system or an optical automatic power management system, etc.

2. Description of Related Art

In a monitoring system or other similar applications, currently there is not a system or a chip which is integrated with a photo sensor and is capable of determining whether there is an object moving and converting it to an electronic signal. The closest prior art is to detect whether an object is approaching by means of an infrared transmitter and receiver, and to provide a simple control signal to open or close an automatic door or to turn on or off a display broadcasting an advertisement and so on. If a higher level security is required, multiple sets of infrared transmitter and receiver are provided. Such mechanism is not precise enough for movement detection because it can not detect a tiny movement. This kind of system can only detect whether there is an object entering or exiting the monitored range, but can not distinguish any tiny movement within the range, and neither can it filter out an object (such as a fan) moving with a fixed frequency. The control signal it generates is too rough that it cannot be used for making a precise determination. For example, the control signal can not be used for generating different levels of alarm signals to indicate different levels of security threats.

If such determination is to be done by means of precise image recognition and analysis, in current state of the art, a high level image sensor (camera), and a powerful computer with high level image-recognition software are required. This involves not only very high cost, but also limitations due to the computing capability of the computer. The image resolution, the image refreshing rate and the number of images (camera or monitor number) that can be handled simultaneously are all limited.

If a movement can be determined more precisely, such determination can be applied to a wide variety of applications other than just the monitoring system. For example, when a television (TV) screen, a computer screen or a projection system is used for watching a video program (such as a TV program, a digital video disk, a video tape, etc.), it often happens that a user is absent or asleep but the power is still on. With more precise movement determination, an optical automatic power management system can be introduced to turn off the power according to whether a movement of the user is detected. Obviously the aforementioned rough determination with an infrared transmitter and receiver (for automatic door) can not be applied to such optical automatic turn-off system; instead, more precise image determination is required. Otherwise, anytime when there is an object (e.g., furniture) between the infrared transmitter and receiver, the automatic turn-off function can not be enabled. If the system is designed in such a way that any continuously detected object is treated as a noise and filtered out, the power may be turned off by mistake when the user is still using the system.

In view of the foregoing, the present invention discloses a motion image data generator, a system using the motion image data, and a method thereof, to solve the above problems. The system using the motion image data can be for example a monitoring system or an optical automatic power management system, etc.

With the present invention, a monitoring system can receive the motion data at the same time when it receives an image, requiring no further image processing and determination. The system can simultaneously handle multiple images. To process high resolution images, it is not required to lower the image refreshing rate.

### SUMMARY OF THE INVENTION

The first objective of the present invention is to provide a motion image data generator.

The second objective of the present invention is to provide a system using the motion image data, for example but not limited to an optical automatic power management system or a monitoring system.

The third objective of the present invention is to provide a method for generating motion image data.

The fourth objective of the present invention is to provide a method for processing an image with only one single buffer.

To achieve the objectives mentioned above, from one perspective, the present invention provides a motion image data generator comprising: a photo sensor for capturing an image and converting it to digital image data; and a motion detection and processing circuit coupled to the photo sensor for comparing two digital image data outputted from the photo sensor to determine whether there is an object moving, and generating a corresponding output.

In the aforementioned motion image data generator, the motion detection and processing circuit preferably provides an output which includes motion data indicating information of one or more of the followings: whether there is any change of a corresponding pixel in an image, an extent of change of the pixel, or a weighting of the pixel. The motion data and the image data can be combined as motion image data.

The aforementioned motion detection and processing circuit preferably includes: a motion detection circuit for receiving the digital image data outputted from the photo sensor and generating the motion data; and a processing circuit for generating motion image data according to the digital image data outputted from the photo sensor and the motion data outputted from the motion detection circuit.

Preferably, the motion detection circuit uses only one single buffer to store the digital image data outputted from the photo sensor.

From another perspective, the present invention provides an optical automatic power management system comprising: the aforementioned motion image data generator and a power management circuit coupled to the motion image data generator for determining whether to enter a power-saving mode according to the output from the motion detection and processing circuit. For example, the power management circuit determines to enter a power-saving mode when the output from the motion detection and processing circuit indicates no object moving for a predetermined time period, or when the output from the motion detection and processing circuit indicates an object moving with a fixed frequency for a predetermined time period.

From another perspective, the present invention provides a method for generating motion image data, comprising: capturing an image; converting the captured image to digital image data; comparing two of the digital image data; generating a motion data according to the comparison of two of the digital image data; and generating motion image data according to the digital image data and the motion data.

Optionally, the aforementioned method for generating motion image data may further comprise: generating an alarm signal according to the motion data or the motion image data.

Optionally, the aforementioned method for generating motion image data may further comprise: providing a light source, for example an infrared light source, and a reflective material in a space where an image needs to be captured.

From another perspective, the present invention provides a method for processing an image with only one single image buffer, comprising: providing a single image buffer; storing a first image data in the single image buffer; receiving a second image data and comparing the second image data with the first image data stored in the single image buffer; when the difference of the two image data is lower than a predetermined threshold, keeping the image data in the image buffer without updating it; and when the difference of the two image data is higher than the predetermined threshold, storing a third image data in the image buffer.

Optionally, the aforementioned method may further comprise: generating motion data according to the difference of two image data. The motion data can be combined with the image data to become motion image data. In addition, the method can provide a weighting to the motion data or sample the motion data whereby data quantity is reduced.

The objectives, technical details, features, and effects of the present invention will be better understood with regard to the detailed description of the embodiments below.

### BRIEF DESCRIPTION OF THE DRAWINGS

FIG. 1 and FIG. 2 show two embodiments of the present invention respectively.

FIG. 3 shows one of the methods for filter processing as an example.

FIG. 4 shows a flow chart according to an embodiment of the present invention.

### DESCRIPTION OF THE PREFERRED EMBODIMENTS

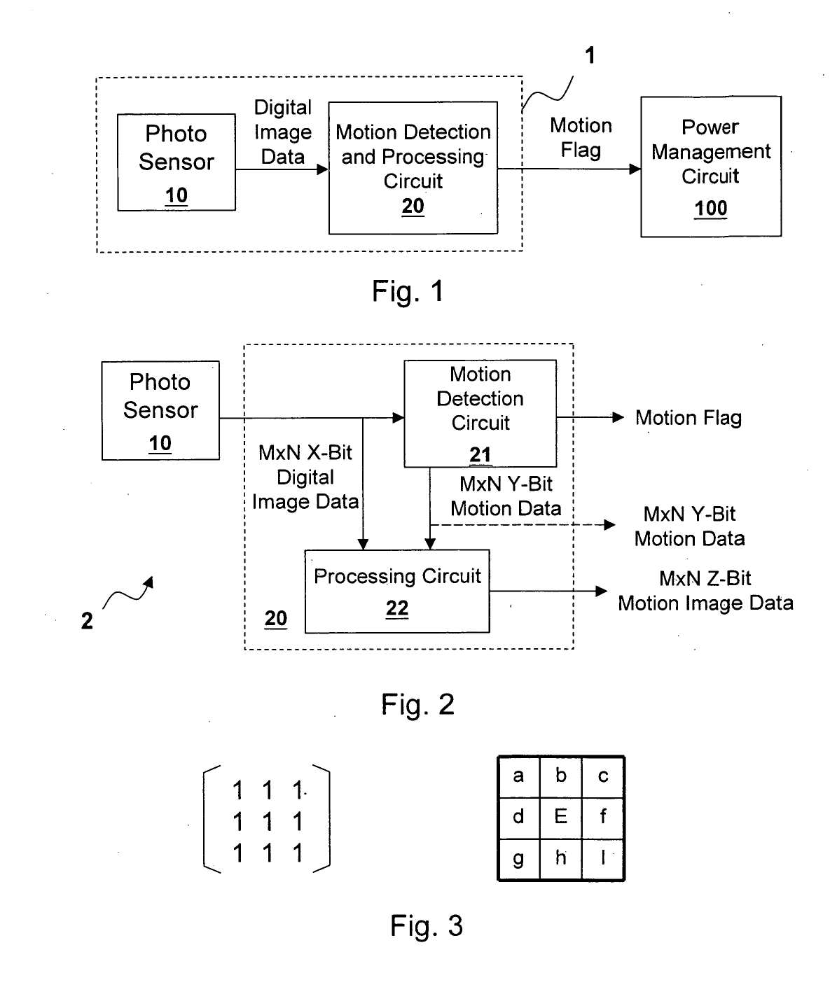

FIG. 1 shows a first embodiment of the present invention. A motion image data generator 1 according to the present invention can be provided in a media player system for power management (thus constituting an optical automatic power management system); or, certainly it can be used in other applications such as in a surveillance monitoring system. The motion image data generator 1 comprises a photo sensor 10 and a motion detection and processing circuit 20. The photo sensor 10 captures an image and converts the image to digital image data. The motion detection and processing circuit 20 is coupled to the photo sensor 10, and determines whether an object is moving in the space where the photo sensor 10 captures images according to the digital image data outputted from the photo sensor 10. More specifically, the motion detection and processing circuit 20 compares two sequential digital image data (i.e., information of two images). When the difference of the two image data is higher than or equal to a predetermined threshold, it is determined that there is an object moving in front of the media player, and a motion index is outputted; for example, a motion flag is set to 1. On the contrary, if the difference of the two image data is lower than the predetermined threshold, it is determined that no object is moving in front of the media player, and an index indicating no motion is outputted; for example, a motion flag is set to 0. The aforementioned “difference” can be determined according to a variety of criteria by various processing methods, such as (but not limited to): calculating brightness or color difference between corresponding pixels of two images; when the brightness or color difference is greater than or equal to a predetermined threshold, determining that the pixel is changed; when the number of changed pixels is greater than or equal to a predetermined number threshold, determining that there is an object moving. Of course, in addition to brightness or color, other image characteristics can also be used to calculate differences.

Assuming that the motion image data generator 1 is used in a media player system for power management: when the motion flag is set to “0” for a period of time which is equal to or longer than a predetermined time threshold, it indicates that there is no object moving for a long time in the space where the photo sensor 10 captures images. Thus, a power management circuit 100 can start various power-saving processes, such as turning off the screen power of the media player system, or turning off the power of the whole media player system, or turning off the power of the system by stages, i.e., turning off the power for some of the circuits at first and then turning all the power off after a period of time. Depending on whether there is a built-in power management system already in the media player system itself, the power management circuit 100 can be provided to the media player system as an additional circuit, or it is only required for the motion image data generator to provide a signal to the power management circuit already existing in the media player system. In the former case, the power management circuit 100 and the motion image data generator 1 can be integrated in one circuit if necessary.

In determining whether an object is moving, the present invention can further exclude an object moving with a fixed frequency, such as a fan, so that the determination is more precise. The motion detection and processing circuit 20 can calculate the period of the movement of an object (by calculating the time length between two occurrences wherein a difference between two images is equal to or higher than a predetermined threshold), or the power management circuit 100 can calculate the period of time between two occurrences that the motion flag changes from “0” to “1”. When the period of time between two occurrences that the motion flag changes from “0” to “1” repeats a certain times (indicating a fixed frequency by which an object is moving for a certain period of time), it can be determined that there is an object moving with a fixed frequency in the space where the photo sensor 10 captures images. Under such circumstance, in an optical automatic power management system, it can be determined to enter the power-saving mode; in a surveillance monitoring system, it can be determined that there is no safety concern (or the safety concern level is low).

After entering the power-saving mode, the system can be recovered to a normal operation mode either manually or according to a detection of an object movement. In the latter condition, when the system is in the power-saving mode, the photo sensor 10 keeps capturing images, and the motion detection and processing circuit 20 continues determining whether there is an object moving. When an object movement is detected, the power management circuit 100 leaves the power-saving mode. In the power-saving mode, the photo sensor 10 and the motion detection and processing circuit 20 can operate with a lower clock frequency for saving power.

FIG. 2 shows another embodiment of the present invention. In this embodiment, a motion image data generator 2 comprises the photo sensor 10 and the motion detecting and processing circuit 20, and the motion detecting and processing circuit 20 includes a motion detecting circuit 21 and a processing circuit 22. The motion detection circuit 21 and the processing circuit 22 are shown as two separate circuits for illustrative purpose. In an actual circuit, their functions can be achieved by only one digital signal processor (DSP) 20, or some of the functions can be achieved by software or firmware.

In this embodiment, the photo sensor 10 captures an image, and converts it to digital data. Assuming that an image has a dimension of M×N pixels (for example but not limited to 640×480 or 160×120, etc.), and each pixel is represented by an X-bit digital data, then the photo sensor 10 outputs M×N X-bit digital data. The motion detection circuit 21 compares the M×N X-bit digital image data with previously stored digital image data, and sets the motion flag according to the comparison result. Furthermore, the motion detection circuit 21 also processes the M×N X-bit digital image data to generate M×N Y-bit motion data. For example, the X-bit digital image data is an 8-bit data indicating brightness, color, or other characteristics, while the Y-bit motion data is only 1-bit, indicating whether the corresponding pixel is changed. The Y-bit motion data can certainly be more bits to indicate more information, such as an amount of change. The Y-bit motion data can be outputted directly (as shown by the dash line in the figure) or outputted through the processing circuit 22 after processed thereby. The processing circuit 22 generates Z-bit motion image data according to the X-bit digital image data and the Y-bit motion data. The motion image data includes image data and motion information. In the above description, X, Y, and Z are all positive integers; Z can be larger than, equal to or less than X+Y. For example, if X is an 8-bit brightness data and Y is a 2-bit data indicating an amount of change, then Z can be a 10-bit motion image data including the 8-bit brightness data of each pixel and the 2-bit information indicating the amount of change, or 9-bit, including the 8-bit brightness data of each pixel and only 1-bit information indicating whether the corresponding pixel is changed, or 11-bit, including the 8-bit brightness data of each pixel data and the 2-bit information indicating the amount of change, plus a parity bit, or a weighting bit, or the like.

If the present invention is applied to a surveillance monitoring system, a next stage circuit (not shown) can generate different levels of alarm signals according to the motion data or the motion image data. For example, a higher level alarm can be generated if an object movement is detected in a more sensitive region, and a lower level alarm for a lower security region, and so on.

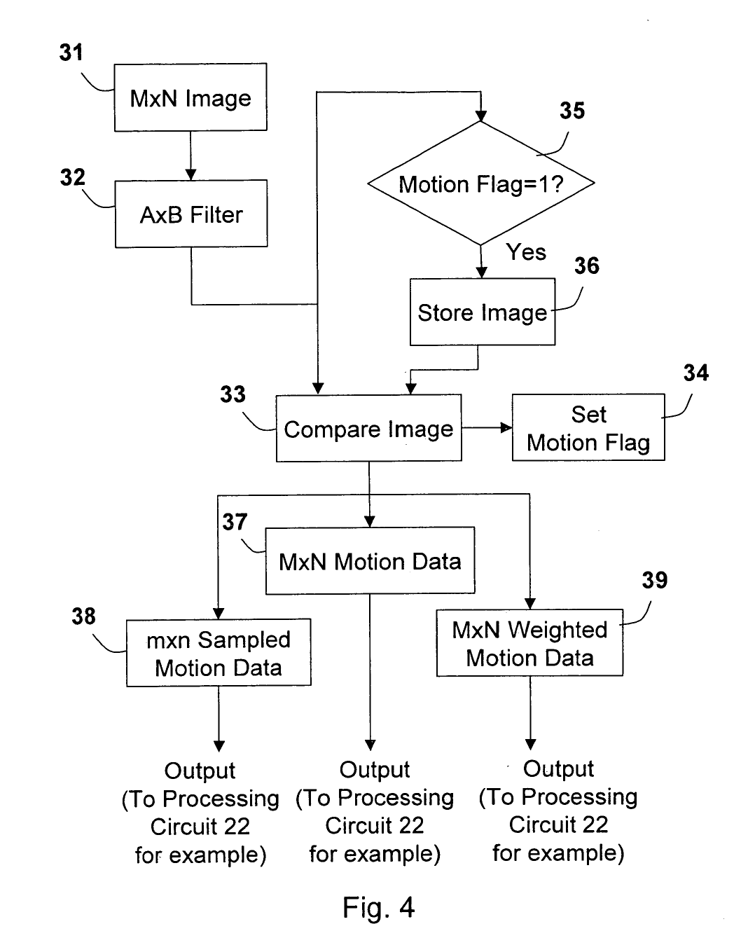

FIG. 4 shows a flow chart illustrating the present invention from a process point of view. First, the motion image data generator 1 or 2 obtains image data of M×N pixels (step 31). In step 32, preferably, the image data is filtered before other steps are taken; for example, each pixel and its neighboring pixels are operated with an A×B matrix for image edge sharpening, smoothing, or other processing. By way of example, a pixel E and its neighboring pixels are as shown in the right side of FIG. 3, and the A×B matrix for example can be a 3×3 matrix shown in the left side of FIG. 3. In this example it is a smoothing process on the pixel E so that the filtered pixel E becomes an average of its original value and the neighboring 8 pixels:

E(filtered)=(a+b+c+d+E(original)+f+g+h+i)/9

Certainly, the A×B matrix is not limited to a 3×3 matrix, but can be a matrix of other sizes, such as 3×1, 5×5, etc. The numbers in the matrix can be different from what are shown in FIG. 3 according to the desired purpose for processing; and the step 32 is an optional step which can be omitted.

In the next step (step 33), the system compares the current M×N image data with previously stored M×N image data. For example, this may be done by subtracting one image data from the other. According to the result, when the difference between the two image data is greater than or equal to the predetermined threshold, the motion flag is set to 1 (step 34). Furthermore, when the motion flag is 1, the current or next image data is stored to replace the previously stored image data (step 35, 36).

In practical implementation, if the current image data needs to be stored to replace the previous image data in step 36, two buffers must be provided, one for storing the image data for comparison and the other for storing the current image data. After the comparison is done, the current image data will be stored in the first buffer to replace the previous image data for comparison. However, according to the present invention, it is not required to provide two buffers; only one buffer which stores image data for comparison is enough. For example, let it be assumed that the motion flag is currently 0; the buffer presently stores the image data of time T0, and the system is currently receiving an image data of time T1. The system receives the image data of time T1 and directly compares the image data of time T1 with image data of time T0 (i.e., the image data of time T1 is not stored before it is operated with the image data of time T0; the operation is directly performed), and because the motion flag is 0, the image data of time T1 is not stored in the buffer. When the comparison result shows that the difference is greater than or equal to the predetermined threshold, the motion flag is set to 1. Thereafter, the next image data of time T2 is stored in the buffer to replace the image data of time T0 because the motion flag is 1. Though the image data of time T2 is not the image data of time T1, the photo sensor 10 has a pretty high frame rate in general, so the accuracy to determine whether an object is moving is not adversely impacted. The image data of time T2 is compared with the image data in the buffer (the image data of time T0) before or when it is stored in the buffer; thereafter, the image data in the buffer is replaced by the image data of time T2. In accordance with the present invention, for example, the image data in the buffer can be sequentially updated pixel by pixel, i.e., in the embodiment above, the first pixel of the image data of time T2 (referred to as T2−pixel 1) is compared with the first pixel of the image data in the buffer (referred to as T0−pixel 1); thereafter, T2−pixel 1 is stored in the buffer to replace T0−pixel 1, while at the same time T2−pixel 2 can be compared with T0−pixel 2.

In addition to the advantage that only one buffer is required, the system according to the present invention does not need complicated calculations for filter operation because the system only processes filter operation on the current image data. (For example, some image processing technology requires calculation for recursive average, but such complicated calculation is not required in this invention.) The present invention is advantageous over prior art with respect to the hardware cost, power consumption and processing efficiency.

Still referring to FIG. 4, the optical automatic power management system 1 shown in FIG. 1 may only perform steps 31-36 mentioned above, while the optical automatic power management system 2 shown in FIG. 2 further performs one or more of steps 37-39. After the comparison in step 33, the system generates motion data according to the digital image data; the generation of the motion data may relate or not relate to the comparison result of step 33. For example, the motion data can be generated only when the difference between the two image data is larger than or equal to a predetermined threshold, or the motion data can be generated regardless what the comparison result is.

Steps 37-39 are different output forms, as explained below:

Step 37: as mentioned earlier, the motion data can be only 1-bit, indicating whether the corresponding pixel is changed, or it can include multiple bits to express more information; in the latter case, for example, assuming that the digital image data outputted from the photo sensor 1 is an 8-bit (0-255) brightness data, and the motion data is 2-bit, the motion data can express the amount of change in the corresponding pixel by, for example: 00 to indicate that the brightness difference between the pixel of the current image and a corresponding pixel in a previously stored image is in the range of 0-63; 01 to indicate that the brightness difference is in the range of 64127; to indicate that the brightness difference is in the range of 128-491; and 11 to indicate that the brightness difference is in the range of 192-255.

Another example of Step 37: let it be assumed that the digital image data outputted from the sensor 10 is an 8-bit (0-255) brightness data, the motion data is 2-bit, and the difference threshold is 63; thus, for example, the amount of change can be expressed by: 00 to indicate that the brightness difference between the pixel of the current image and a corresponding pixel in a previously stored image is in the range of 64-79, 01 to indicate that the brightness difference is in the range of 80-111, to indicate that the brightness difference is in the range of 112-175, 11 to indicate that the brightness difference is in the range of 176-255, and no output to indicate that the brightness differences is less than 63. Note that in the above arrangement, the information ranges expressed by the numbers of the motion data are not identical, that is, the ranges of bright difference corresponding to 00, 01, 10, and 11 are not equal. Since an amount of change nearer the difference threshold is more meaningful, the closer to the threshold the difference is, the more narrow an interval of the motion data is defined.

Step 38: the M×N motion data are sampled to obtain motion data of a smaller size, m×n, wherein for example m=M/2 and n=N/2.

Step 39: again, let it be assumed that the digital image data outputted from the sensor 10 is an 8-bit (0-255) brightness data, and the motion data is 2-bit. Thus, for example, 00 can indicate that the brightness difference between the pixel of the current image and a corresponding pixel in a previously stored image is lower than the threshold. 01, 10, and 11 respectively indicate the weightings of the pixel when it is subject to image processing (such as edge sharpening, smoothing, or other processing) by a next-stage circuit. For example, a pixel located in the junction between two drastically different image features can be assigned a higher weighting, and so on.

The motion data obtained by steps 37-39, for example, can be provided to the processing circuit 22 of FIG. 2 to generate motion image data, or provided to other circuits for other purposes, such as for issuing different levels of alarms and so on.

The method described with reference to FIG. 4 is not limited to determining whether an object is moving. Such image processing method with one single image buffer can be applied to any image processing system. The basic principle is to store a first image data in a single image buffer, and compare a second image data, which is currently received, with the first image data stored in the buffer. The second image data is not stored, so a second buffer is not required. When the difference between the two image data is lower than the threshold, the image data in the buffer is not updated; and when the difference between the two image data is higher than the threshold, a third image data which is next received is stored in the buffer to replace the first image data. The first, second and third image data are not necessarily continuous data.

The motion image data generator of the present invention can be widely applied to various systems which require determining object movements, and it is much superior to the prior art when applied to a surveillance monitoring system. In prior art, multiple sets of infrared transmitters and receivers must be provided to avoid dead zones for a more rigorous surveillance monitoring system. In the present invention, determination is made according to images rather than the transmission and receipt of infrared light beams, so only one set of light source and receiver is required. If higher intensity of light is desired, it is only required to provide one or more reflective materials in the monitored space (for example, on the wall in the monitored space). Therefore, this invention is more advantageous.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the functions completed by a single circuit can instead be performed by multiple separate circuits or software. For another example, setting the digital motion flag is only one of the methods for “indicating whether there is a change” and the present invention is not limited to this. Instead of using a digital bit to express and calculate time, the same power management function can be achieved in analog fashion, such as by charging a capacitor when there is a change between two images, and discharging the capacitor when there is no change; when the capacitor completely discharges, the system enters the power-saving mode. In view of the foregoing, the spirit of the present invention should cover all such and other modifications and variations, which should be interpreted to fall within the scope of the following claims and their equivalents.

What is claimed is:

1. A motion image data generator comprising:
a photo sensor for capturing an image and converting it to digital image data; and
a motion detection and processing circuit coupled to the photo sensor for comparing two digital image data outputted from the photo sensor to determine whether there is an object moving, and generating a corresponding output.

2. The generator of claim 1, wherein the motion detection and processing circuit provides an output which includes motion data indicating information of one or more of the followings: whether there is any change of a corresponding pixel in an image, an extent of change of the pixel, or a weighting of the pixel.

3. The generator of claim 2, wherein at least two of the motion data indicate information spaces of different sizes.

4. The generator of claim 1, wherein the motion detection and processing circuit provides an output which includes motion image data, the motion image data comprising digital image data outputted from the photo sensor and the motion data generated by the motion detection and processing circuit.

5. The generator of claim 4, wherein the motion detection and processing circuit includes:
a motion detection circuit for receiving the digital image data outputted from the photo sensor and generating the motion data; and
a processing circuit for generating motion image data according to the digital image data outputted from the photo sensor and the motion data outputted from the motion detection circuit.

6. The generator of claim 5, wherein the motion detection circuit uses only one single buffer to store the digital image data outputted from the photo sensor.

7. An optical automatic power management system comprising:
a motion image data generator including:
a photo sensor for capturing an image and converting it to digital image data; and
a motion detection and processing circuit coupled to the photo sensor for comparing two digital image data outputted from the photo sensor to determine whether there is an object moving, and generating a corresponding output; and
a power management circuit coupled to the motion image data generator for determining whether to enter a power-saving mode according to the output from the motion detection and processing circuit.

8. The system of claim 7, wherein the motion image data generator and the power management circuit are integrated to a single circuit.

9. The system of claim 7, wherein it is determined to enter the power-saving mode when the output from the motion detection and processing circuit indicates no object moving for a predetermined time period.

10. The system of claim 7, wherein it is determined to enter the power-saving mode when the output from the motion detection and processing circuit indicates an object moving with a fixed frequency for a predetermined time period.

11. The system of claim 7, wherein it is determined that there is an object moving when a difference of the two digital image data is equal to or greater than a predetermined threshold.

12. The system of claim 7, wherein when the system enters the power-saving mode, the photo sensor continues capturing images and the motion detection and processing circuit continues determining whether an object is moving; and the system leaves the power-saving mode when it is determined that an object is moving.

13. A method for generating a motion image data, comprising:
capturing an image;
converting the captured image to digital image data;
comparing two of the digital image data;
generating a motion data according to the comparison of two of the digital image data; and
generating motion image data according to the digital image data and the motion data.

14. The method of claim 13, further comprising: determining whether there is an object moving according to the comparison of two of the digital image data.

15. The method of claim 14, further comprising: determining whether the object is moving with a fixed frequency.

16. The method of claim 14, further comprising: generating a signal such that a circuit enters a power-saving mode when it is determined that no object is moving or an object is moving with a fixed frequency for a predetermined time period.

17. The method of claim 13, wherein the motion data indicates information of one or more of the followings: whether there is any change of a corresponding pixel in an image, an extent of change of the pixel, or a weighting of the pixel.

18. The method of claim 13, wherein at least two of the motion data indicate information spaces of different sizes.

19. The method of claim 13, further comprising: generating an alarm signal according to the motion data or the motion image data.

20. The method of claim 13, further comprising: providing a light source, and a reflective material in a space where an image needs to be captured.

21. A motion image data comprising data of plural pixels, wherein every pixel data includes X-bit image data and Y-bit motion data, where X and Y are positive integers.

22. A method for processing an image with only one single image buffer, comprising:
providing a single image buffer;
storing a first image data in the single image buffer;
receiving a second image data and comparing the second image data with the first image data stored in the single image buffer;
when the difference of the two image data is lower than a predetermined threshold, keeping the image data in the image buffer without updating it; and
when the difference of the two image data is higher than the predetermined threshold, storing a third image data in the image buffer.

23. The method of claim 22, further comprising: generating a flag when the difference of the two image data is higher than the predetermined threshold.

24. The method of claim 22, further comprising: filtering the image data.

25. The method of claim 22, further comprising: generating motion data according to the difference of two image data.

26. The method of claim 25, further comprising: generating motion image data by combining the motion data and the image data.

27. The method of claim 25, further comprising: providing a weighting to the motion data.

28. The method of claim 25, further comprising: sampling the motion data whereby data quantity is reduced.
